(19) United States
(12) Patent Application Publication
(10) Pub. No.: US 2021/0378324 A1
(43) Pub. Date: Dec. 9, 2021

(54) RESPI-SAFE FILTER MASK

(71) Applicant: Basem Hassan, Matawan, NJ (US)

(72) Inventor: Basem Hassan, Matawan, NJ (US)

(21) Appl. No.: 16/896,514

(22) Filed: Jun. 9, 2020

(51) Int. Cl. A41D 13/11; A62B 23/02; A62B 18/02

(52) U.S. Cl. CPC A41D 13/1138; A62B 18/025; A62B 23/025

(57) ABSTRACT

An article of manufacture for a wearable facemask with a filter pocket that accepts a filter element is disclosed. The mask is a two-part system comprised of a removable filter element and an all-cotton mask. The mask possesses a pocket sized to accept the filter element while positioning the filter element to predominantly cover the nose and mouth of a user ensuring that the user inhales filtered air.

### TECHNICAL FIELD

This application relates in general to an article of manufacture for providing personal protection devices, and more specifically, to an article of manufacture for a wearable facemask with a filter pocket that accepts a filter element.

### BACKGROUND

Traditionally, filtration material is designed with straps to be worn on the face directly as a disposable, one-time-use mask. Medical-grade personal protection equipment (PPE) should be reserved for medical employees. This includes protective filtration systems such as N95 face filters, surgery face filters, and other personal filtration devices worn around the face of the healthcare professional. Non-healthcare individuals are currently required to wear some form of face covering when in public for compliance with current federal and state laws. Homemade masks are designed out of cotton and provide no adequate filtration protection against airborne particles that are virus-sized. This creates a dangerous false sense of security and increases the likelihood of public exposure.

Therefore, a need exists for a mask having a two-part filtration system designed to give a level of airborne particle protection appropriate for non-medical daily use. The masks should be comfortable to wear, easy to clean, and provide a sufficient level of protection currently not available in existing devices.

### SUMMARY

In accordance with the present invention, the above and other problems are solved by providing an article of manufacture for a wearable facemask with a filter pocket that accepts a filter element according to the principles and example embodiment disclosed herein.

In one embodiment, the present invention, known as the Respi-Safe Filter Mask, is an article of manufacture for a wearable facemask with a filter pocket that accepts a filter element. The mask is a two-part system consisting of a removable filter element and an all-cotton mask. The mask possesses a filter pocket sized to accept a filter element while positioning the filter element to predominantly cover the nose and mouth of a user ensuring that the user inhales filtered air.

The foregoing has outlined rather broadly the features and technical advantages of the Respi-Safe Filter Mask in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIGS. 1a-b illustrate an example embodiment for prior art breathing masks.

FIG. 2 illustrates an example embodiment of a filter element for use in a personal protection device according to the present invention.

FIG. 3 illustrates an example embodiment of an article of manufacture for providing a wearable facemask with a filter pocket that accepts a filter element according to the present invention.

FIG. 4 illustrates an example of a user wearing an article of manufacture for providing a wearable facemask with a filter pocket that accepts a filter element according to the present invention.

### DETAILED DESCRIPTION

This application relates in general to an article of manufacture for a personal protection device, and more specifically, to an article of manufacture for a wearable facemask with a filter pocket that accepts a filter element according to the present invention. An embodiment of the present invention will be described in detail with reference to the drawings, wherein like reference numerals represent like parts and assemblies throughout the several views. Reference to this embodiment does not limit the scope of the invention, which is limited only by the scope of the claims attached hereto. Additionally, any examples set forth in this specification are not intended to be limiting and merely set forth some of the many possible embodiments for the claimed invention.

In describing the embodiment of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers” should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specifications and claims are approximations that may vary depending upon the desired properties sought to be obtained by the present disclosure. At the very least, and not as an attempt to limit the application of the doctrine of equivalents to the scope of the claims, each numerical parameter should be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The terms “customer” and “user” refer to an entity, e.g. a human, using the Respi-Safe Filter Mask including any filter elements associated with the invention. The term user herein refers to one or more users.

The term “invention” or “present invention” refers to the invention being applied for via the patent application with the title “Respi-Safe Filter Mask.” Invention may be used interchangeably with filter mask.

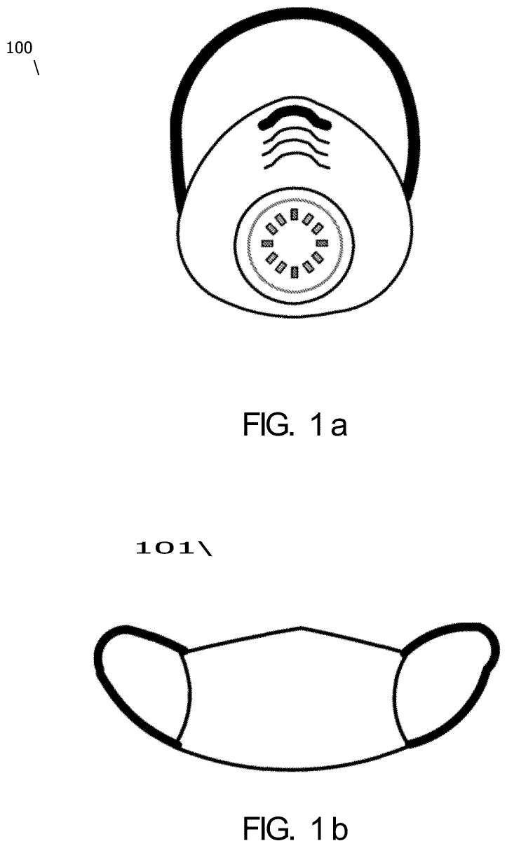

In general, the present disclosure relates to an article of manufacture for a personal protection device. To better understand the present invention, FIGS. 1a-b illustrate an example embodiment for prior art breathing masks. FIG. 1a illustrates an N95 filter 101 that is typically worn by users in the medical professions as a personal protection device. The N95 filter 101 is a wearable filter and not a comfortable mask. FIG. 1b illustrates a typical cloth mask 102 that does not include any filter device to ensure that the user does not inhale undesirable elements.

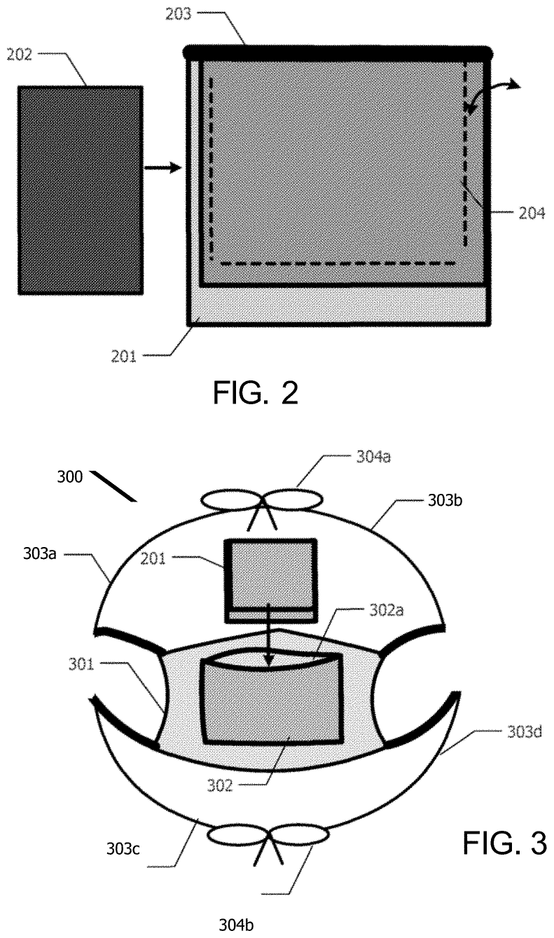

FIG. 2 illustrates an example embodiment of a filter element for use in a personal protection device according to the present invention. A first part of the device is the filtration cartridge 201 for providing a filtering component to the mask. In one embodiment, the filter element 201 may be designed using 3M™ 2500-2800 filter material with the option of an activated carbon interior 202. Filter material 201 is cut to one of two sizes 3×10 (large) or 3×8 (small), folded 203 over to its final dimension (3×5/3×4) and sewn shut with cotton thread 204.

A layer of activated carbon fiber 202 may be added inside the filter element 201 cartridge between the two 3M filter layers. The filter element 201 cartridge is rated for 85% efficiency in capturing particles in the virus-sized range and rated for 6 months of heavy use (12 hrs/day) before it needs replacement. Use of the filter element 201 combined with the activated carbon cartridge 202 may also capture scent molecules aiding highly sensitive people to function normally. Filter element 201 cartridges may be removed daily for sterilization.

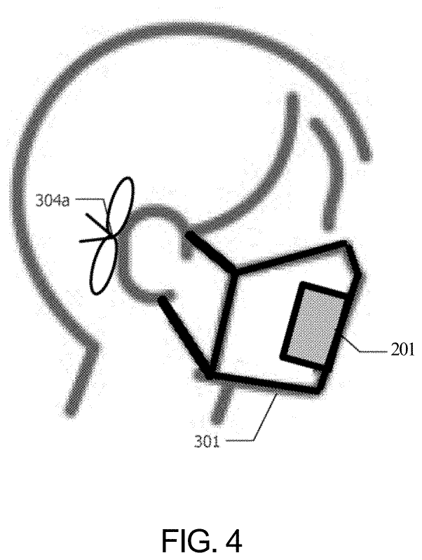

FIG. 3 illustrates an example embodiment of an article of manufacture for providing a wearable facemask with a filter pocket that accepts a filter element according to the present invention. The filter element 201 is the first part of the device. An all-cotton mask 301 is the second part of the device. The cotton mask 301 is designed with an interior pouch 302 that matches the filter element 201 cartridge size. The mask 301 is designed with key strength stitching points 305 and key expansion stitch pleats 306 to accommodate the 3M filter element 201 cartridge and allow it to naturally curve around the user's face for increased efficiency. Instead of elastic straps to hold the mask on the user's ears, each Respi-Safe Filter Mask is designed with an adjustable comfort strap 303a-d that ties 304a-b around the user's head or ears, whichever is most comfortable for the user. The filter element 201 can be removed from the mask pouch 302a to allow for cleaning of the mask in regular laundry.

FIG. 4 illustrates an example of a user wearing an article of manufacture for a wearable facemask with a filter pocket that accepts a filter element according to the present invention. This two-part system allows the user to own a personal mask 301 as an accessory/clothing apparel while being able to discretely use filter element cartridges 201 to cleanse the air. In the embodiment of FIG. 4, the mask 301 is secured with a comfort strap around the user's ears tied behind the ears 304a-b. The embodiment of FIG. 3 shows the mask 301 being secured with comfort strap around a user's head. Other possible items such as stretchable fabric, elastic straps, and other attachment mechanisms may be used in other embodiments to provide a comfortable fit to most users.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. The phrase “connected to a billboard” means any component or smart device that is capable to connect to a billboard or billboards by any means wired and/or wireless, regardless if a server or server(s) or computer system(s) is required in any step of the connection process. The phrase “to be displayed on a billboard or billboards” or “display on a billboard or billboards” or “displayed on the billboard” or “to display the content(s) of choice” or “contents displayed” or “displayed content” refers to displaying the content's or contents' representative words, letters, numbers, designs, figures, images, videos, sounds or other symbolic presentation to the sign copy of the billboard as selected by users or operators in a format that is recognizable by the selected billboard(s) to display representative and recognizable content to the audience. Any singular term used in this present patent application is applicable to its plural form even if the singular form of any term is used.

What is claimed:

1. An article of manufacture for a wearable facemask with a filter pocket that accepts a filter element, the article comprises:
a filter element cartridge capable of capturing unwanted particles;
a wearable soft mask having an inner pouch sized to accept the filter element cartridge positioned about a user's nose and mouth; and
a plurality of attachment straps for securing the article to a user's face.

2. The article of manufacture according to claim 1, wherein the filter element comprises a filter material folded in two and stitched closed to form a single element.

3. The article of manufacture according to claim 2, wherein the filter element further comprises a layer of activated carbon fiber located between the folded filter material.

4. The article of manufacture according to claim 1, wherein the wearable soft mask is made of cotton with a plurality of expanding pleats for adjusting the mask around the filter element and the user's face.

5. The article of manufacture according to claim 1, wherein the adjustment straps comprise four cotton straps long enough to be tied around the user's head.

6. The article of manufacture according to claim 1, wherein the adjustment straps comprise four cotton straps long enough to be tied around the user's ears.

7. An article of manufacture for a wearable facemask with a filter pocket that accepts a filter element, the article comprises:
a filter element cartridge capable of capturing unwanted particles; the filter element comprises a filter material folded in two and stitched closed to form a single element and a layer of activated carbon fiber located between the folded filter material;
a wearable soft mask having an inner pouch sized to accept the filter element cartridge positioned over a user's nose and mouth; the wearable soft mask is made of cotton with a [symbol]
